(19) United States
(12) Patent Application Publication
(10) Pub. No.: US 2008/0184968 A1
(43) Pub. Date: Aug. 7, 2008

(54) Solenoid valve driver and fuel injection system equipped with the same for compensating lag of operation of solenoid valve

(75) Inventor: Yuichiro Matsuura, Kariya-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 12/010,892

(22) Filed: Jan. 30, 2008

(30) Foreign Application Priority Data
Feb. 2, 2007 (JP) 2007-024339

(51) Int. Cl. F02M 51/06

(52) U.S. Cl. 123/490

(57) ABSTRACT

A solenoid valve driver is provided which may be employed in automotive fuel injection system. The solenoid valve driver includes a capacitor which is to be discharged to energize a coil of a solenoid valve and a controller. The controller determines a discharge start time that is a time when the capacitor is to be started to be discharged to energize the coil of the solenoid valve. When the discharge start time is reached in a condition that a charged voltage of the capacitor is out of a target voltage level, the controller advances the discharge start time to eliminate a lag of operation of the solenoid valve.

### CROSS REFERENCE TO RELATED DOCUMENT

The present application claims the benefit of Japanese Patent Application No. 2007-24339 filed on Feb. 2, 2007, the disclosure of which is totally incorporated herein by reference.

### BACKGROUND OF THE INVENTION

1. Technical Field of the Invention

The present invention relates generally to a solenoid valve driver designed to discharge electrical energy which is higher in voltage than that in a power supply to a coil of a solenoid valve to improve the response speed of operation of the solenoid valve, and a fuel injection system which may be employed in automotive engines and is equipped with such a solenoid valve driver.

2. Background Art

Solenoid valves are typically used in fuel injectors which work to inject fuel into cylinders of an internal combustion engine mounted in, for example, an automobile. The fuel injectors are controlled in operation by a fuel injection system. Specifically, the fuel injection system works to control energization of coils (i.e., the time and duration of energization of the coils) installed in the fuel injectors to regulate the time when the fuel injectors are to be opened (usually called the fuel injection timing) and the quantity of fuel to be injected into the engine (usually called the injection quantity).

Japanese Patent First Publication Nos. 2001-15332 and 2002-180878 teach the above type of fuel injection systems which have a step-up transformer to step up the voltage of a power supply to charge a capacitor, discharge electrical energy from the capacitor to supply a high current (i.e., peak current) to the coil of the fuel injector for opening the fuel injector quickly, and then provide a constant flow of current to the coil to keep the fuel injector opened until a given injection duration expires.

There are known some of the above type of fuel injection systems which are designed to perform multiple injections of fuel into each cylinder of the engine in every engine operating cycle (i.e., a four-stroke cycle) including intake or induction, compression, combustion, and exhaust in order to improve the fuel economy and quality of exhaust emissions, and minimize mechanical noise or vibration of the engine or perform overlapping injections to spray the fuel into some of the cylinders of the engine at overlapping times.

The capacitor, as used in the above fuel injection systems, is charged by the step-up transformer to a stated target voltage level. In the multi-injection mode or the overlapping injection mode of operation of the fuel injection system, the capacitor is, as demonstrated in FIG. 8, discharged in sequence at relatively shorter intervals. This may result in a lack of a charging duration for the capacitor (i.e., a lack of electrical energy stored in the capacitor), thus causing the coil of each of the fuel injectors (which will also be called an injector coil below) to be energized at a voltage level (65±3V in the example of FIG. 8) lower than the target voltage level of the electrical energy to be stored in the capacitor.

The first to third curves from the top of the drawing of FIG. 8 represent currents INJ flowing through the injector coils when the capacitor is discharged three times in sequence to energize the injector coils to achieve a sequence of injections of fuel into the engine. After reaching the target peak value (i.e., 11±1 A), each of the currents INJ is kept at a first constant level until a given period of time elapses since the injector coil is energized and then kept at a second constant level lower than the first constant level until an injection termination time is reached.

When the output voltage of the capacitor drops before the capacitor is charged to the target voltage level, it will result in a lack of ability of the capacitor to supply the current INJ to the injector coil, thus causing an increased time to be consumed between the start of energization of the injector coil and when the current INJ reaches the target peak value. This results in an increase in response time required by the injector to open.

The problem underlying the fuel injection control will be described below in detail with reference to FIG. 9.

The uppermost line represents a drive signal to be outputted in the form of a pulse from a controller such as a microcomputer to a driver circuit which works to supply a flow of current to the injector coil. When the drive signal is changed from a low to a high level, the driver circuit discharges the capacitor to supply the current INJ to the coil of a corresponding one of the fuel injectors and then regulates the current INJ to the first and second constant levels stepwise after it reaches the target peak value.

In the example of FIG. 9, the time when the injector is to be opened (which will also be referred to as an injector opening point below) is when the current INJ reaches half the target peak value. The drop or lack in voltage charged in the capacitor, as described above, will result in a time delay for the current INJ to reach the target peak value. The current INJ is, therefore, also subjected to a time delay in reaching half the target peak value, thus resulting in a lag between when the drive signal is changed to the high level and when the fuel injector is opened.

Specifically, when the voltage charged in the capacitor is lower than the target voltage level, it will cause the injector opening point to be delayed, as illustrated in FIG. 9, by a valve opening delay time T_{delay}. “CIRCUIT LAG”, as labeled in FIG. 9, represents an operation time lag between when the drive signal is changed to the high level and when the driver circuit starts to discharge the capacitor to energize the injector coil. The operation time lag is constant regardless of the voltage charged in the capacitor.

The delay of the injector opening point, as described above, results in a decreased time length the fuel injector is held opened. This causes the amount of fuel to be discharged from the fuel injector to be less than a stated amount.

In recent years, there have been increasing demands for low fuel consumption in automobiles in compliance with market requests or government regulations, which requires control of combustion of a lean fuel in automotive engines. It is, therefore, necessary to control the injection of fuel into the engine finely and accurately. The effects of the opening lag of the fuel injectors on the quantity of fuel to be sprayed into the engine are, therefore, should be considered.

The lack in voltage charged in the capacitor may be avoided by increasing the capacity of the capacitor, but however, it results in increases in size and production cost of the system.

### SUMMARY OF THE INVENTION

It is therefore a principal object of the invention to avoid the disadvantages of the prior art.

It is another object of the invention to eliminate a time lag of operation of a solenoid valve when a capacitor is discharged to energize a coil of the solenoid valve before the voltage charged in the capacitor reaches a target level.

According to one aspect of the invention, there is provided a solenoid valve driver which comprises: (a) a capacitor in which electric energy is stored which is to be discharged to energize a coil of at least one solenoid valve; (b) a charging circuit that charges the capacitor to bring a charged voltage of the capacitor to a target voltage level; and (c) a controller working to determine a discharge start time that is a time when the capacitor is to be started to be discharged to energize the coil of the solenoid valve and discharge the capacitor when the discharge start time is reached. When the discharge start time is reached in a condition that the charged voltage of the capacitor is out of the target voltage level, the controller advances the discharge start time. Specifically, when it is required to discharge the capacitor to energize the coil of the solenoid valve in the condition that the charged voltage of the capacitor is out of the target voltage level, the controller works advance the discharge start time to eliminate a lag of operation of the solenoid valve.

In the preferred mode of the invention, the controller stores a correction time for the discharge start time therein and corrects the discharge start time by the correction time.

The controller may alternatively determine a value of the charged voltage of the capacitor before being discharged and calculate the correction time based on the measured value of the charged voltage. The controller corrects the discharge start time by the correction time.

The solenoid valve may be an injector which is to be opened upon energization of the coil to inject fuel into an internal combustion engine.

According to the second aspect of the invention, there is provided a solenoid valve driver which comprises: (a) a capacitor in which electric energy is stored which is to be discharged to energize a coil of at least one solenoid valve; (b) a charging circuit that charges the capacitor to bring a charged voltage of the capacitor to a target voltage level; and (c) a controller working to determine a discharge start time that is a time when the capacitor is to be started to be discharged to energize the coil of the solenoid valve and discharge the capacitor when the discharge start time is reached. The controller determines whether the capacitor is in a lack-of-charge state where the charged voltage is lower than the target voltage level or not. When it is determined that the capacitor is in the lack-of-charge state, the controller corrects the discharge start time to advance the discharge start time.

In the preferred mode of the invention, when it is determined that the capacitor will be in the lack-of-charge state at the discharge start time, the controller brings the discharge start time into coincidence with a time when the capacitor is to be discharged in a condition where the charged voltage is at the target voltage level.

The controller stores a correction time for the discharge start time therein and corrects the discharge start time by the correction time.

The controller may alternatively determine a value of the charged voltage of the capacitor before being discharged and calculate the correction time based on the measured value of the charged voltage. The controller corrects the discharge start time by the correction time.

The solenoid valve may be an injector which is to be opened upon energization of the coil to inject fuel into an internal combustion engine.

According to the third aspect of the invention, there is provided a solenoid valve driver which comprises: (a) a capacitor in which electric energy is stored which is to be discharged to energize a coil of at least one solenoid valve; (b) a charging circuit that charges the capacitor to bring a charged voltage of the capacitor to a target voltage level; and (c) a controller working to determine a discharge start time that is a time when the capacitor is to be started to be discharged to energize the coil of the solenoid valve and discharge the capacitor when the discharge start time is reached. The controller measures a value of the charged voltage of the capacitor before being discharged and corrects the discharge start time based on the measured value of the charged voltage.

In the preferred mode of the invention, the solenoid valve may be an injector which is to be opened upon energization of the coil to inject fuel into an internal combustion engine.

According to the fourth aspect of the invention, there is provided a fuel injection apparatus which comprises: (a) an injector equipped with a coil, the injector being opened to spray fuel upon energization of the coil; (b) a capacitor in which electric energy is stored which is to be discharged to energize the coil of the injector; (c) a charging circuit that charges the capacitor to bring a charged voltage of the capacitor to a target voltage level; and (d) a controller working to determine a discharge start time that is a time when the capacitor is to be started to be discharged to energize the coil of the injector and discharge the capacitor when the discharge start time is reached. The controller works to perform a sequence of spray operations to spray the fuel from the injector and advance the discharge start time for second or subsequent one of the sequence of spray operations.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which shows a fuel injection system according to the first embodiment of the invention;

FIG. 2 is a timechart which demonstrates operations of an electronic control unit (ECU) installed in the fuel injection system of FIG. 1;

FIG. 3 is a flowchart of a program to be executed in an ECU installed in the fuel injection system of FIG. 1 to determine an injection timing;

FIG. 4(a) is a view which shows a change in charged voltage of a capacitor for use in energizing a fuel injector installed in the fuel injection system of FIG. 1;

FIG. 4(b) is a view which shows a delay of time when an injector starts to be opened which arises from discharging of a capacitor in a condition where a charged voltage is lower than a target voltage level;

FIG. 5 is an explanatory view which demonstrates operations of a fuel injection system of the first embodiment;

FIG. 6 is a flowchart of a program to be executed in an ECU to determine an injection timing according to the second embodiment of the invention;

FIG. 7 is a graph which represents a data map showing a relation between a charged voltage of a capacitor and a delay of time when an injector starts to be opened;

FIG. 8 is an explanatory view which shows a relation between current blowing through an injector and a charged voltage of a capacitor in a conventional fuel injection system; and

FIG. 9 is an explanatory view which shows operations of a conventional fuel injection system.

### DESCRIPTION OF THE PREFERRED EMBODIMENTS

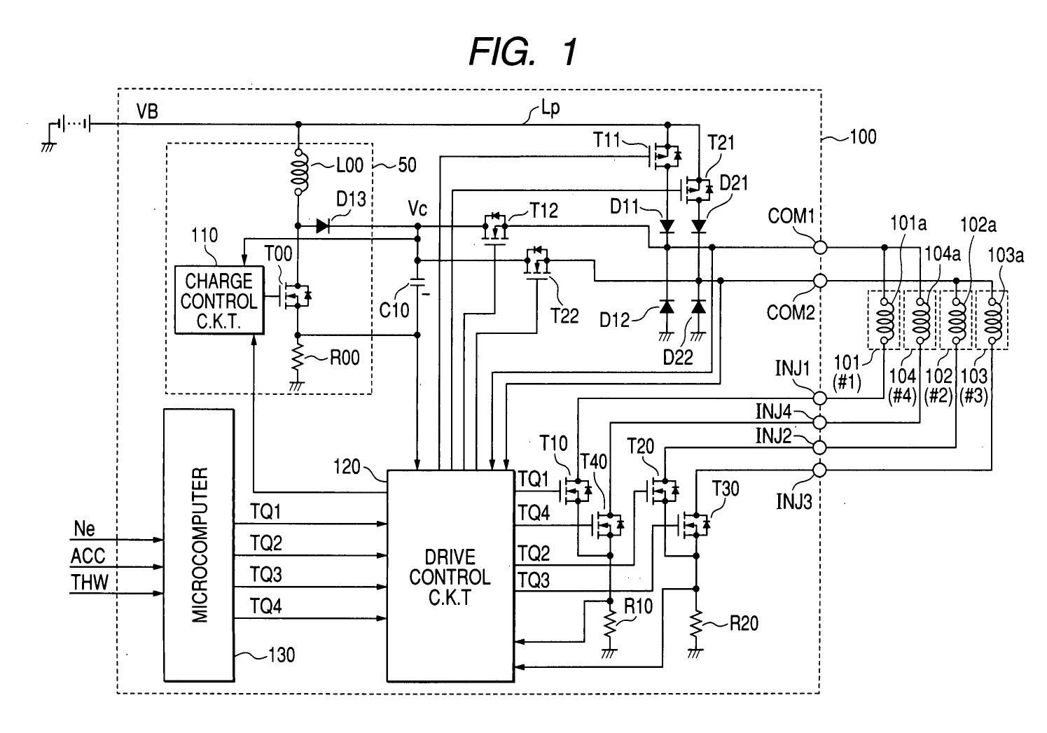

Referring to the drawings, wherein like reference numbers refer to like parts in several views, particularly to FIG. 1, there is shown a fuel injection system which may be employed in controlling an operation of an automotive internal combustion engine and is equipped with a solenoid valve driver according to the first embodiment of the invention.

The fuel injection system, as referred to herein, is implemented by an electronic control unit (ECU) 100.

The ECU 100 is engineered to actuate fuel injectors 101, 102, 103, and 104 to inject fuel into cylinders #1, #2, #3, and #4 of a four-cylinder internal combustion engine mounted in an automotive vehicle. Specifically, the ECU 100 works to control times (will also be referred to as energization times below) when coils 101a, 101b, 101c, and 101d of the injectors 101 to 104 are to be energized and durations (will also be referred to as energization durations) for which the coils 101a to 101d are to be kept energized to regulate the time when the injectors 101 to 104 are to be opened (usually called the injection timing) and the quantity of fuel to be sprayed by the injectors 101 to 104 into the engine (usually called the injection quantity). The injectors 101 to 104 are each made of a normally-closed solenoid valve and to be opened upon energization of the coils 101a to 104a to commence the injection of fuel into the engine and closed upon deneregization of the coils 101a to 104a to terminate the injection of fuel into the engine.

The ECU 100 breaks down the injectors 101 to 104 for the four cylinders #1 to #4 into a first group of the injectors 101 and 104 (which will also be referred to below as a first injector group) and a second group of the injectors 102 and 103 (which will also be referred to below as a second injector group). Upstream ends (i.e., positive terminals) of the coils 101a and 104a of the first injector group are connected to a common terminal COM1 of the ECU 100. Upstream ends of the coils 102a and 103a for the second injector group are connected to a common terminal COM2 of the ECU 100. Two of the injectors 101 to 104 of each of the first and second injector groups are not to be actuated simultaneously.

Each of downstream ends (i.e., negative terminals) of the coils 1011a to 104a is connected to one of output terminals of a corresponding one of transistors T10, T20, T30, and T40 through one of terminals INJ1, INJ2, INJ3, and INJ4. The other output terminals of the transistors T10 to T40 are connected to a ground line through current-measuring resistors R10 and R20 which are provided for the first and second injector groups, respectively. The ECU 100 measures the current flowing through the coils 101a and 104a of the injectors 101 and 104 through the transistors T10 and T40 in the form of voltage, as developed at the current-measuring resistor R10, and also measures the current flowing through the coils 102a and 103a of the injectors 102 and 103 through the transistors T20 and T30 in the form of voltage, as developed at the current-measuring resistor R20. Each transistors installed as a switching device in the ECU 100 is a MOSFET.

The ECU 100 also includes transistors T11, T12, T21, and T22, diodes D11, D12, D21, and D22, a capacitor C10, a charging circuit 50, a drive control circuit 120, and a microcomputer 130 which is of a typical structure made up of a CPU, a ROM, and a RAM. The charging circuit 50 works as a step-up transformer to step-up the voltage VB, as outputted from a storage battery mounted in the vehicle, to produce a higher voltage as a source voltage to charge the capacitor C10. The drive control circuit 120 works to control operations of the above transistors and the charging circuit 50.

The microcomputer 130 works to monitor operating conditions of the engine using the speed Ne of the engine, the position of an accelerator pedal ACC, and the temperature of engine coolant THW, as measured through known sensors (not shown), and produce and output injection signals TQ1 to TQ4 for the cylinders # 1 to #4 to the drive control circuit 120. When the injection signals TQ1 to TQ4 are at a high level, the drive control circuit 120 energizes the coils 101a to 104a of the injectors 101 to 104 to open them. Specifically, the drive control circuit 120 outputs each of the injection signals TQ1 to TQ4, as inputted from the microcomputer 130, to the gate of a corresponding one of the transistors T10 to T40. For instance, the drive control circuit 120 outputs the injection signal TQ1 to the gate of the transistor T10 for the first cylinder #1 and also outputs the injection signal TQ2 to the gate of the transistor T20 for the second cylinder #2.

The charging circuit 50 is equipped with an inductor L00, a transistor T00, and a charge control circuit 110 which controls an operation of the transistor T00. The inductor L00 is connected at an end thereof to a power supply line Lp at which the battery voltage VB is developed and at the other end to one of output terminals of the transistor T00. Between the other output terminal of the transistor T00 and ground, a current-measuring resistor R00 is disposed. The charge control circuit 110 connects with the gate of the transistor T00 and outputs an on-off signal to turn on or off the transistor T00.

The charging circuit 50 also includes a diode D13 through which the positive terminal of the capacitor C10 is joined to a junction between the inductor L00 and the transistor T00. The negative terminal of the capacitor C10 is joined to a junction between the transistor T00 and the resistor R00.

When the transistor T00 is turned on and off, it will cause the flyback voltage which is higher in level than the battery voltage VB to be created at the junction of the inductor L00 and the transistor T00 to charge the capacitor C10 through the diode D13. Specifically, when a charge permission signal, as outputted from the drive control circuit 120, is changed to an active level (i.e., a high level), the charge control circuit 110 turns on and off the transistor T00 cyclically and at the same time monitors the voltage Vc at the positive terminal of the capacitor C10 (i.e., a charged voltage of the capacitor C10 which will also be referred to below as a capacitor voltage). When the capacitor voltage Vc reaches a stated target voltage level (e.g., 65V) or the charge permission signal is changed to an inactive level (i.e., a low level), the charge control circuit 110 stops the on-off operation of the transistor T00 to keep it off to terminate the charging of the capacitor C10.

The transistor T12 is used to discharge electrical energy from the capacitor C10 to the coils 101a and 104a joined to the common terminal COM1. Specifically, when the drive control circuit 120 turns on the transistor T12, the positive terminal (i.e., a higher voltage side) of the capacitor C10 is joined to the common terminal COM1.

Similarly, the transistor T22 is used to discharge electrical energy from the capacitor C10 to the coils 102a and 103a joined to the common terminal COM2. When the drive control circuit 120 turns on the transistor T22, it establish an electric connection between the positive terminal of the capacitor C10 and the common terminal COM2.

The transistor T11 is used to provide a constant flow of current to the coil 101a and 104a joined to the common terminal COM1. When the drive control circuit 120 turns on the transistor T11 while the transistor T10 or T40 is in the on-state, it will cause the current to flow from the power supply line Lp through the blocking diode D11 to the coil 101a or 104a joined to one of the transistors T10 and T40 which is in the on-state. The diode D12 serves as a feedback diode in controlling the constant flow of current through the coil 101a or 104a. Specifically, when the transistor T11 is changed from the on-state to the off-state while either of the transistors T10 and T40 is placed in the on-state, the diode D12 works to establish a flow of current through the coil 101a or 104a.

Similarly, the transistor T21 is used to provide a constant flow of current to the coil 102a and 103a joined to the common terminal COM2. When the drive control circuit 120 turns on the transistor T21 while the transistor T20 or T30 is in the on-state, it will cause the current to flow from the power supply line Lp through the blocking diode D21 to the coil 102a or 103a joined to one of the transistors T20 and T30 which is in the on-state. The diode D22 serves as a feedback diode in controlling the constant flow of current through the coil 101a or 104a. Specifically, when the transistor T21 is changed from the on-state to the off-state while either of the transistors T20 and T30 is placed in the on-state, the diode D22 works to establish a flow of current through the coil 102a or 103a.

The drive control circuit 120 is designed to perform six operations as discussed below.

### First Operation

The drive control circuit 120 works to output the injection signals TQ1 to TQ4, as inputted from the microcomputer 130, to the gate of the transistors T10 to T40, respectively.

### Second Operation

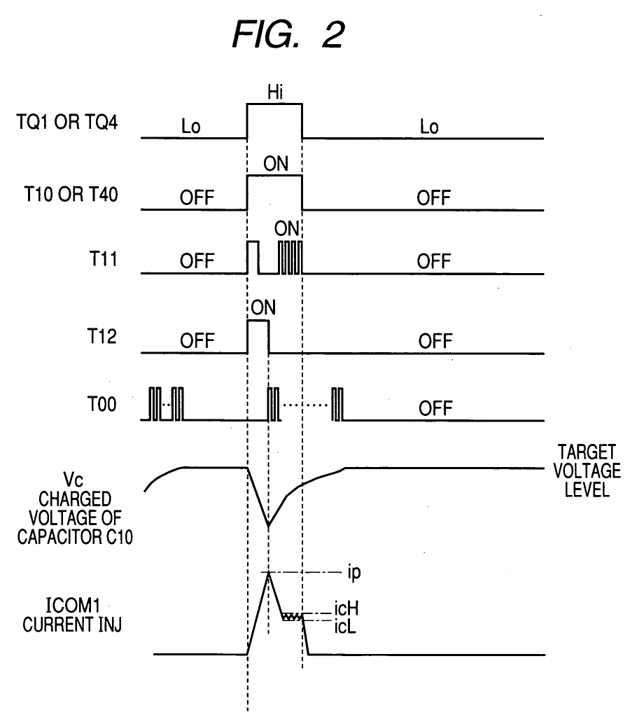

When the capacitor C10 is stopped from being discharged to energize the coils 101a to 104a, that is, when the transistors T12 and T22 are placed in the off-state, the drive control circuit 120 changes the charge permission signal to the active level and outputs it to the charge control circuit 110 to turn on the charging circuit 50 to charge the capacitor C10 until the capacitor voltage Vc reaches the target voltage level (see fourth to sixth curves in FIG. 2).

### Third Operation

When either of the injection signals TQ1 and TQ4 for the first injection group, as outputted from the microcomputer 130, is changed from the low to high level, the drive control circuit 120 turns on the transistor T12. One of the injection signals TQ1 to TQ4 placed in the high level will be generally expressed by TQx below.

When the transistor T12 is turned on, it will cause, as can be seen in FIG. 2, one of the transistors T10 and T40 corresponding to the injection signal TQx to be turned on, so that the capacitor voltage Vc is applied to the common terminal COM1 to discharge the electrical energy from the capacitor C10 to one of the coils 101a to 104a corresponding to the injection signal TQx. The one of the coils 101a to 104a is supplied with a high current from the capacitor C10 to open a corresponding one of the injectors 101 and 104. In FIG. 2, “ICOM1” represents the current flowing through the common terminal COM1 which is the current INJ flowing through one of the coils 101a to 104a of the injectors 101 to 104 corresponding to the injection signal TQx.

After turning on the transistor T12, the drive control circuit 120 determines the current INJ based on the voltage appearing at the resistor R10 and, when the current INJ, as illustrated in FIG. 2, reaches the target peak value ip (11 A in this embodiment), turns off the transistor T12.

### Fourth Operation

After turning off the transistor T12 in the third operation, the drive control circuit 120 continues to monitor the current INJ using the voltage appearing at the resistor R10. The drive control circuit 120 turns on and off the transistor T11 cyclically to bring the value of the current INJ below the target peak value ip until the injection signal TQx is changed from the high to low level.

Specifically, as illustrated in FIG. 2, the drive control circuit 120 enters a constant current control mode in order to keep the current flowing through a corresponding one of the coils 101a and 104a constant while the injection signal TQx is appearing. The drive control circuit 120 turns on the transistor T11 when the current INJ is lower than a lower threshold value icL and turns off the transistor T11 when the current INJ is higher than an upper threshold value icH. Specifically, after the current INJ decreases from the target peak value ip below the lower threshold value icL, the drive control circuit 120 turns the transistor T11 on and off in a cycle to bring an average of the current INJ to a constant value which is intermediate between the upper threshold value icH and the lower threshold value icL.

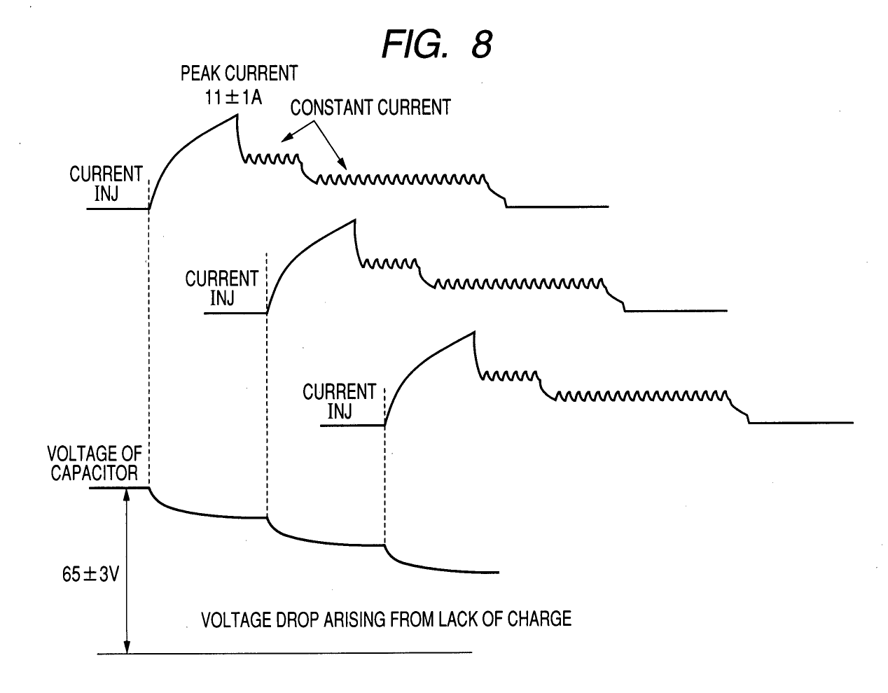

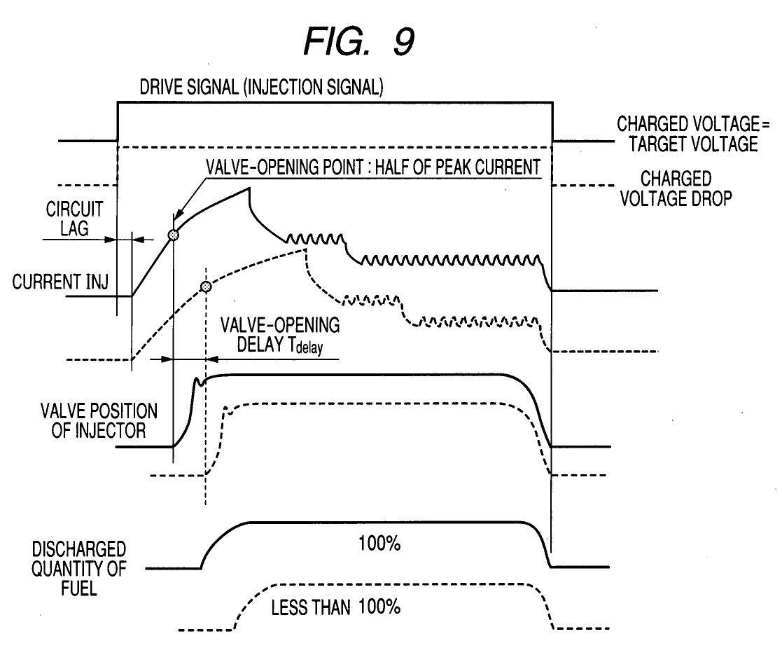

For the sake of simplicity, FIG. 2 exemplifies the lower threshold value icL and the upper threshold value icH as being constant at all the time and the current INJ as being brought to a given constant value. In practice, however, the drive control circuit 120 works to bring, as illustrated in FIG. 8, the current INJ to the first constant level until a given period of time elapses since a corresponding one of the coils 101a to 104a is energized and then brings it to the second constant level lower than the first constant level until the injection signal TQx is changed to the low level, that is, a given injection termination time is reached. Specifically, the drive control circuit 120 changes the lower threshold value icL and the upper threshold value icH between a duration until a given period of time passes since a corresponding one of the coils 101a to 104a is energized and a following duration until the injection signal TQx is changed to the low level.

As apparent from the above discussion, after turning off the transistor T12, the driver control circuit 120 performs the constant current control operation to provide a constant flow of current to a corresponding one of the coils 101a and 104a of the first injector group from the power supply line Lp through the transistor T11 and the diode D11, thereby keeping a corresponding one of the injectors 101 and 104 opened. Subsequently, as illustrated in FIG. 2, when the injection signal TQx is changed to the low level, the driver control circuit 120 turns off one of the transistors T10 and T40 corresponding to the injection signal TQx and also turns off the transistor T11, thereby deenergizing the one of the coils 101a and 104a to terminate the injection of fuel into the engine.

### Fifth Operation

The drive control circuit 120 also perform the same operation as the third operation on the transistor T22.

Specifically, when either of the injection signals TQ2 and TQ3 for the second injection group, as outputted from the microcomputer 130, is changed from the low to high level, the drive control circuit 120 turns on the transistor T22. When the transistor T12 is turned on, it will cause one of the transistors T20 and T30 corresponding to the injection signal TQx (i.e., one of the injection signals TQ2 and TQ3 having been changed to the high level) to be turned on, so that the capacitor voltage Vc is applied to the common terminal COM2 to discharge the electrical energy from the capacitor C10 to one of the coils 102a to 103a corresponding to the injection signal TQx. The one of the coils 102a to 103a is supplied with a high current from the capacitor C10 to open a corresponding one of the injectors 102 and 103. After turning on the transistor T22, the drive control circuit 120 determines the current INJ based on the voltage appearing at the resistor R20 and, when the current INJ reaches the target peak value ip, turns off the transistor T22.

### Sixth Operation

The drive control circuit 120 also perform the same operation as the fourth operation on the transistor T21.

After turning off the transistor T22 in the fifth operation, the drive control circuit 120 continues to monitor the current INJ using the voltage appearing at the resistor R20. The drive control circuit 120 turns on and off the transistor T21 cyclically to bring the value of the current INJ below the target peak value ip and keep it constant until the injection signal TQx is changed to low level.

Specifically, the drive control circuit 120 enters the constant current control mode in order to keep the current flowing through a corresponding one of the coils 102a and 103a constant while the injection signal TQx is appearing. In other words, after turning off the transistor T22, the drive control circuit 120 supplies a constant flow of current to a corresponding one of the coils 102a and 103a for the second injector group from the power supply line Lp through the transistor T21 and the diode D21, thereby keeping a corresponding one of the injectors 101 to 104 opened.

The fuel injection system (i.e., the ECU 100) may be designed to perform the multiple injections or the overlapping injections of fuel into the engine. When, in either of such injection modes, a time interval between two consecutive starts of injection events (which will be referred to below as an injection-to-injection interval) is shorter than a stated period of time (i.e., a time interval between two consecutive starts of discharging of the capacitor C10), the charge permission signal, as outputted from the drive control circuit 120 to the charge control circuit 110, is kept at the inactive level after the completion of discharging of the capacitor C10 for a preceding one of the injection events, thereby permitting the capacitor C10 to be discharged without being charged. This is because when the injection-to-injection interval is short undesirably, the charging circuit 50 may encounter a difficulty in performing a switching operation to stop charging the capacitor C10 only during the discharging of the capacitor C10 due to a lag in operation of the charging circuit 50, so that the capacitor C10 is charged during the discharging thereof. In order to avoid this problem, the drive control circuit 120 of this embodiment continues to stop charging the capacitor C10. This, however, may cause the capacitor C10 to be discharged to energize one of the coils 101a to 104a of the injectors 101 to 104 even though the capacitor voltage Vc is still lower than the target voltage level (e.g., 65V), that is, the capacitor C10 is not yet charged sufficiently, which results in a lag in opening a corresponding one of the injectors 101 to 104, as discussed in the introductory part of this application, so that the quantity of fuel to be sprayed into the engine is decreased below a design value.

In order to alleviate the above drawback, the microcomputer 130 is designed to perform an operation, as discussed below.

The microcomputer 130 has installed therein signal outputting timers, one for each of the injectors 101 to 104, for use in outputting the injection signals TQ1 to TQ4 for the cylinders #1 to #4 of the engine, respectively. When entering a fuel injection control mode, the microcomputer 130 determines the injection duration for which a selected one of the injectors 101 to 104 is to be kept opened subsequently and the injection termination time at which the one of the injectors 101 to 104 is to be closed and sets such values in the signal outputting timer.

When the time earlier than the injection termination time by the injection duration is reached in one of the signal outputting timers, the microcomputer 130 changes a corresponding one of the injection signals TQ1 to TQ4 to the high level. Subsequently, when the injection termination time is reached, the microcomputer 130 changes the one of the injection signals TQ1 to TQ4 to the low level.

Consequently, the time earlier than the injection termination time by the injection duration will be a discharge start time when the capacitor C10 is to be started to be discharged to energize a corresponding one of the coils 101a to 104a of the injectors 101 to 104. The microcomputer 130 sets the discharge start time using a combination of the injection duration and the injection termination time.

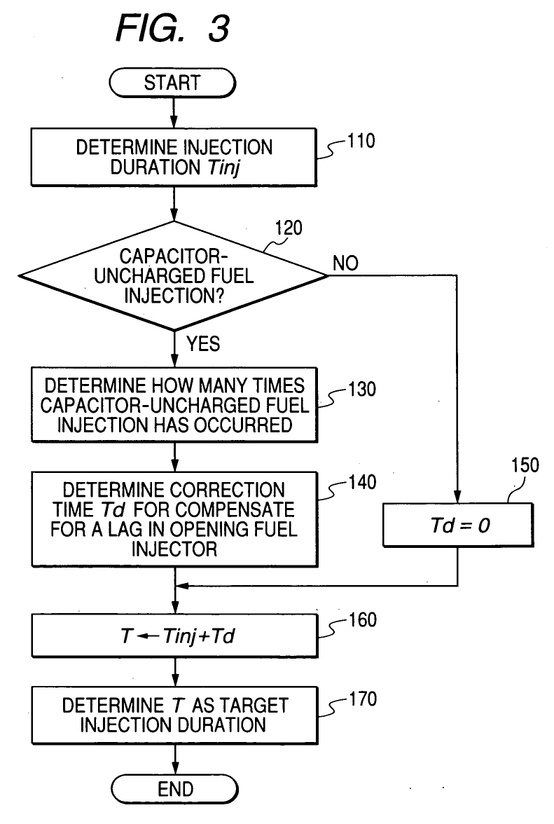

The microcomputer 130 performs an injection timing determining program, as shown in FIG. 3, immediately before execution of each of a sequence of injections of fuel into the engine.

After entering the program, the routine proceeds to step 110 wherein the injection duration Tinj that is the length of time a selected one of the injectors 101 to 104 is to be opened and the injection termination time that is the time when the one of the injectors 101 to 104 should be closed to terminate the injection of fuel into the engine are determined based on operating conditions of the engine.

The routine proceeds to step 120 wherein it is determined whether the injection of fuel to be executed subsequently is a capacitor-uncharged fuel injection or not. The capacitor-uncharged fuel injection is the event of injection of fuel executed when the capacitor C10 is not yet charged, that is, the capacitor voltage Vc is still lower than the target voltage level after the capacitor C10 is discharged for the preceding event of injection of fuel into the engine. Specifically, it is determined whether a time interval between the discharge start time when the capacitor C10 should be discharged, as determined using values of a combination of the injecting duration Tinj and the injection termination time set in step 110 one program execution cycle earlier, and the discharge start time, as determined using values of a combination of the injecting duration Tinj and the injection termination time set in step 110 in this program execution cycle, is less than the stated period of time, as described above, or not. If so, the drive control circuit 130, as already described, holds the capacitor C10 from being charged. It is, thus, determined that the injection of fuel to be executed subsequently is the capacitor-uncharged fuel injection.

If the following injection of fuel is determined in step 120 as being the capacitor-uncharged fuel injection, in other words, it is determined that the discharge start time, as determined in this program execution cycle, is the time when the capacitor voltage Vc does not yet reach the target voltage level, then the routine proceeds to step 130 wherein it is determined how many times the event of the capacitor-uncharged fuel injection has occurred successively. Note that the capacitor-uncharged fuel injection following the event of capacitor-charged fuel injection that is the injection of fuel executed after the capacitor C10 is charged up to the target voltage level is counted as the first one. Therefore, when a plurality of events of fuel injection have occurred successively at time intervals shorter than the stated period of time, the second of the events of fuel injection is determined as the capacitor-uncharged fuel injection having occurred first.

In step 140, a correction time Td which compensates for a time lag in operating a selected one of the injectors 101 to 104 which will occur in a mode of the capacitor-uncharged fuel injection is determined as a function of the number of events of the capacitor-uncharged fuel injection, as counted in step 130. The routine then proceeds to step 160. Note that the correction time Td is a correction value for the injection duration Tinj. The microcomputer 130 has installed therein a nonvolatile memory such as a ROM which stores values of the correction time Td for the number of events of the capacitor-uncharged fuel injection having occurred successively. In step 140, the microcomputer 130 selects the value of the correction time Td from the nonvolatile memory which corresponds to the number of events of the capacitor-uncharged fuel injection, as determined in step 130.

If a NO answer is obtained in step 120 meaning that the following injection of fuel is determined as the capacitor-charged fuel injection, then the routine proceeds to step 150 wherein the correction time Td is set to zero (0).

The routine proceeds to step 160 wherein the time T is determined which is the sum of the injection duration Tinj, as determined in step 110, and the correction time Td, as selected currently. The routine then proceeds to step 170 wherein the time T, as derived in step 160, is determined as a target injection duration, and stored in one of the signal outputting timer which corresponds to one of the cylinders #1 to #4 of the engine into which the fuel is to be injected subsequently. Additionally, the injection termination time, as determined in step 110, is also stored in the one of the signal outputting timers.

As apparent from the above steps, when the correction time Td is set in step 150, that is, when a subsequent event of the injection of fuel into the engine is determined as not being the capacitor-uncharged fuel injection, a corresponding one of the injection signals TQ1 to TQ4 is changed to the high level at the time earlier than the injection termination time, as derived in step 110, by the injection duration Tinj, as derived in step 110, however, when step 140 has been executed, a corresponding one of the injection signals TQ1 to TQ4 is changed to the high level at the time earlier than the injection termination time, as derived in step 110, by the time T, as set in step 160, which is the sum of the injection duration Tinj, as derived in step 110, and the correction time Td, as derived in step 140. Specifically, when a subsequent event of the injection of fuel into the engine is determined as being the capacitor-uncharged fuel injection, the microcomputer 130 switches the time when a corresponding one of the injection signals TQ1 to TQ4 to the high level is advanced by the correction time Td.

How to select the value of the correction time Td from the nonvolatile memory in step 140 will be described below in detail.

The resistance R and inductance L of each of the coils 101a to 104a (will be generally referred to here as an injector coil) are given. The capacity Co and the target charged voltage of the capacitor C10 and the target peak value ip of the current INJ to be supplied to the injector coil are also given. When the injection of fuel is executed one time, it will result in a drop in voltage Vc charged in the capacitor C10. Such a voltage drop may be calculated using the above given values. As an example here, assume that R=1.5Ω, L=1.6 mH, and Co=330 μF.

If the current discharged from the capacitor C10 to the injector coil is defined as i, and the maximum value (i.e., the finally converged value) thereof is defined as 1, we obtain equation (1), as shown below. Rewriting Eq. (1), we obtain equation (2) below.

i=I×(1−e^{-t×R/L}) (1)

t=−L/R×ln(1−i/I) (2)

where I is expressed by Eq. (3) below, and Vc in Eq. (3) is the voltage in the capacitor C10 before discharged.

I=Vc/R (3)

Substituting Eq. (3) into Eq. (2), we obtain a relation between the discharged current I and the time t, as expressed by Eq. (4) below.

t=−L/R×ln(1−i/(Vc/R)) (4)

The target charged voltage of the capacitor C10 is 65V. The voltage of the capacitor C10 before discharged when the mode of the capacitor-uncharged fuel injection is not entered, that is, the mode of the capacitor-charged fuel injection is entered will, therefore, be 65V.

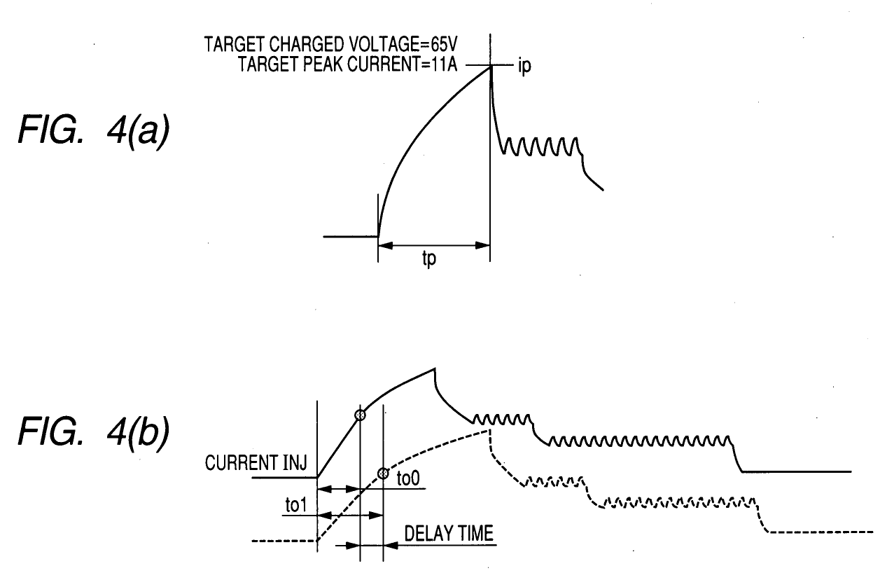

Therefore, when Vc=65V, and i=ip=11 A, t=−0.0016/1.5×In{1−(11/(65/1.5))}=312.3 μs. Specifically, when the mode of the capacitor-charged fuel injection is entered, the time tp (see FIG. 4(a)) required for the current i discharged from the capacitor C10 to the injector coil to reach the target peak value ip (=11 A) will be 312.3 μs.

Since 11 A is equivalent to 11 c/s (coulomb/second), the quantity Qp of charge discharged from the capacitor C10 until the current i discharged from the capacitor C10 reaches the target peak value ip may be expressed in Eq. (5) below by approximating the area, as defined in FIG. 4(a), by the current i discharged from the capacitor C10 as being triangle.

Qp=11×tp×(1/2) (5)

A drop Vdown in charged voltage Vc of the capacitor C10 per event of the injection of fuel into the engine is expressed in Eq. (6) below using a relation of Q=CV.

Vdown=Qp/Co (6)

The drop Vdown in the charged voltage Vc arising from the event of the capacitor-charged fuel injection is calculated as Vc=0.00172/330 μF=5.2V by substituting tp=312.3 μF into Eq. (5) to obtain the quantity Qp of charge discharged from the capacitor C10=0.00172 coulomb and also substituting Qp into Eq. (6).

Accordingly, the charged voltage Vc of the capacitor C10 upon initiation of the capacitor-uncharged fuel injection to be made first following the execution of the capacitor-charged fuel injection will be 59.8V which has been decreased from 65V by 5.2V. 59.8V will be discharged to the injector coil.

The valve-opening point that is the time when each of the injectors 101 to 104 starts to be opened is when the current INJ reaches half the target peak value ip (=ip/2=5.5 A). Thus, in the mode of the capacitor-charged fuel injection, a valve-opening required time to0 (see FIG. 4(b) that is a time interval between when the capacitor C10 starts to be discharged and the valve-opening point will be −0.0016/1.5×ln {1−(5.5/(65/1.5))}=144.8% s where Vc=65V, and i=5.5 A in Eq. (4).

Since the charged voltage Vc of the capacitor C10 has already dropped by 5.2V to 59.8V before initiation of the capacitor-uncharged fuel injection to be made first, the valve-opening required time to1 (see FIG. 4(b)) between when the capacitor C10 starts to be discharged to achieve the capacitor-uncharged fuel injection and the valve-opening point will be −0.0016/1.5×In{1−(5.5/(59.8/1.5))}=158.4 μs where Vc=59.8V, and i=5.5 A in Eq. (4).

Accordingly, the valve-opening point for the capacitor-uncharged fuel injection to be made first will be delayed by to1−to0=13.6 μs behind that in the mode of the capacitor-charged fuel injection, thus resulting in a decrease in actual injection duration by such a delay.

The time tp required for the current i discharged from the capacitor C10 to the injector coil to reach the target peak value ip (=11 A) for the first event of the capacitor-uncharged fuel injection will be 344.4 μs where Vc=59.8V, and i=ip=11 A in Eq. (4).

The drop Vdown in charged voltage Vc arising from the execution of the first event of the capacitor-uncharged fuel injection is calculated to be 5.7V by substituting tp=344.4/t s into Eqs. (5) and (6).

The charged voltage Vc of the capacitor C10 for the second event of the capacitor-uncharged fuel injection will, thus, be 54.1V (=65V−5.2V−5.7V) which has been decreased from 59.8V by 5.7V. 54.1V will, thus, be discharged to the injector coil to achieve the second event of the capacitor-uncharged fuel injection.

Accordingly, in the second event of the capacitor-uncharged fuel injection, the valve-opening required time to 2 between when the capacitor C10 starts to be discharged and the valve-opening point will be 176.5 μs where Vc=54.1V, and i=5.5 A in Eq. (4). The valve-opening point will, thus, be delayed by to 2−to0=31.7 μs behind that in the mode of the capacitor-charged fuel injection.

The delay time of the valve-opening point (i.e., an increase in the valve-opening required time) for the third or subsequent event of the capacitor-uncharged fuel injection may be determined in the same manner as described above.

The microcomputer 130 stores in the nonvolatile memory the delay time in each of a sequence of events of the capacitor-uncharged fuel injection, as calculated in the manner as described above, as a value of the correction time Td for a corresponding one of the events of the capacitor-uncharged fuel injection. For instance, 13.6 μs (=to1−to0) is stored as the value of the correction time Td for the first event of the capacitor-uncharged fuel injection. 31.7 μs (=to2−to0) is stored as the value of the correction time Td for the second event of the capacitor-uncharged fuel injection.

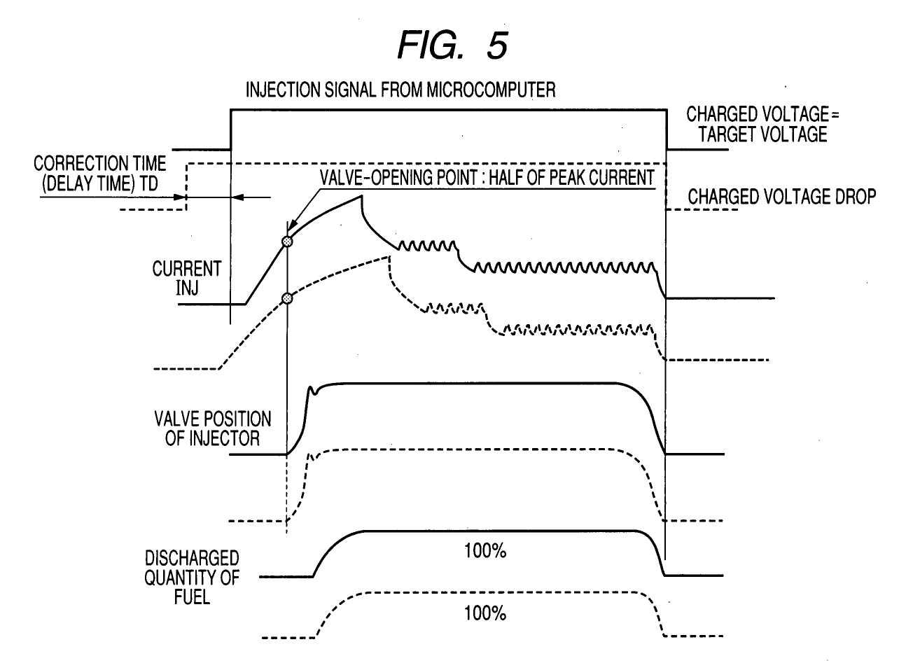

As apparent from the above discussion, when the capacitor-uncharged fuel injection appears in the multiple injection mode or the overlapping injection mode, the ECU 100 works in steps 130 to 170 to add the correction time Td to the injection duration Tinj which is set to end at a reference time that is the injection termination time, thereby advancing, as illustrated by a broken line in FIG. 5, the time when a corresponding one of the injection signals TQ1 to TQ4 is to change to the high level, that is, when the capacitor C10 is to be started to be discharged to energize the injector coil, resulting in advance of the valve-opening point of a corresponding one of the injectors 101 to 104. This results in coincidence of the valve-opening point in the capacitor-uncharged fuel injection mode with that in the capacitor-charged fuel injection mode wherein the fuel is injected into the engine when the charged voltage Vc of the capacitor C10 is at the target voltage level.

The ECU 100 is designed to compensate for a lag in the valve-opening point of one of the injectors 101 to 104 to be energized in the capacitor-uncharged fuel injection mode without increasing the capacity of the capacitor C10, thereby bringing the injection duration Tinj (i.e., the quantity of fuel to be injected) into agreement with a desired value.

The microcomputer 130 of the ECU 100 stores the values of the correction time Td in the nonvolatile memory and selects one of them for correcting the injection duration Tinj, thus minimizing a load on operation of the microcomputer 130.

When the injection-to-injection interval becomes shorter than the stated period of time (i.e., the time interval between two consecutive starts of discharging of the capacitor C10), so that the capacitor-uncharged fuel injection mode appears, the ECU 100 works to correct the discharge start time when the capacitor C10 should be discharged to energize one of the coils 101a to 104a of the injectors 101 to 104. Such correction is made for the second or subsequent one of a sequence of multiple injections of fuel into one of the cylinders #1 to #4 of the engine or for the injection of fuel into one of the cylinders #1 to #4 belonging to one of the first and second injector groups following the injection of fuel into another of the cylinders #1 to #4 belonging to the other of the first and second injector groups in the multiple injection mode.

For instance, when the speed of the engine increases, it may cause the interval between the first of a scheduled sequence of injections of fuel into one of the cylinders #1 to #4 of the engine and the first of a scheduled sequence of injections of fuel into another of the cylinders #1 to #4 to be shorter than the stated period of time depending upon the value thereof. In such a case, the later event of the injection will be the event of the capacitor-uncharged fuel injection. The ECU 100 works to correct the discharge start time when the capacitor C10 should be discharged for the later event of the injection, thereby avoiding a lack of quantity of fuel to be injected into the engine.

Based on the above fact, a determination may alternatively be made in step 120 of FIG. 3 as to whether the speed of the engine is higher than a given value at which the interval between two consecutive timings of injection of fuel into two of the cylinders #1 to #4 of the engine becomes shorter than the stated period of time. If an affirmative answer is obtained, then the routine proceeds to step 130.

The ECU 100 of the second embodiment will be described below. The ECU 100 is identical in hardware with the one in the first embodiment. The same reference numbers as employed in the first embodiment will refer to the same parts, and explanation thereof in detail will be omitted here.

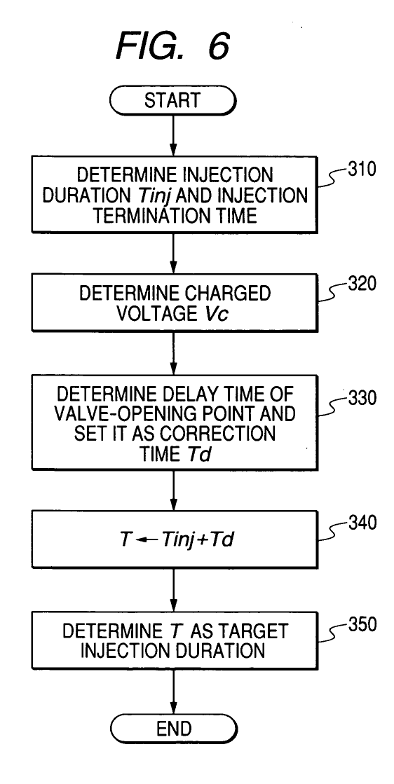

The ECU 100 executes an injection timing control program, as illustrated in FIG. 6, instead of the program of FIG. 3.

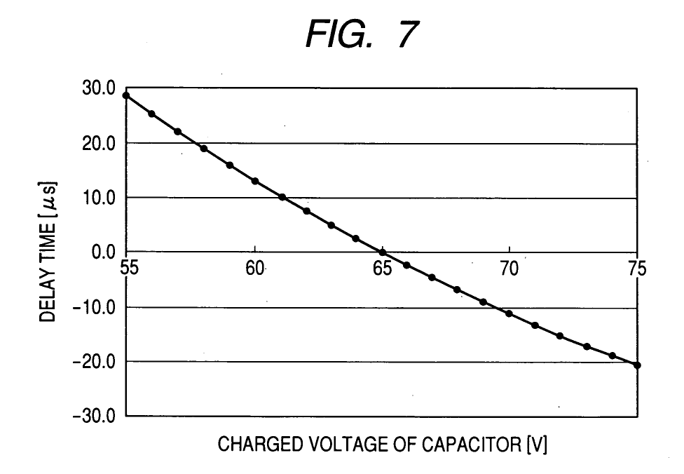

The microcomputer 130 stores a table or data map, as illustrated in FIG. 7, in a nonvolatile memory (not shown) such as a ROM. The data map shows a relation between the charged voltage Vc of the capacitor C10 and the delay time of the valve-opening point of the injectors 101 to 104.

If the value of the charged voltage Vc of the capacitor C10 is known, the valve-opening required time to (i.e., to1 or to2, as described above) which is a time interval between when the capacitor C10 starts to be discharged and the valve-opening point may be calculated by assigning the value of the charged voltage Vc and i=5.5 A to Eq. 4. The delay time of the valve-opening point behind that in the mode of the capacitor-charged fuel injection (i.e., Vc=target voltage level) may be calculated by subtracting the valve-opening required time to0 (=144.8 μs) when the charged voltage Vc is at the target voltage level from the valve-opening required time to. The data map is prepared in this manner.

When the charged voltage Vc of the capacitor C10 is higher than the target voltage level (=65V), it will cause the valve-opening required time to be shorter than that when Vc=target voltage level, so that the valve-opening point is advanced. The delay time of the valve-opening point, as calculated in the above manner, has a negative value. The data map also stores such a negative value. The values in the data map may alternatively be found experimentally.

Upon initiation of the injection timing control program of FIG. 6 in the microcomputer 130, the routine proceeds to step 310 wherein the injection duration Tinj and the injection termination time for subsequent injection of fuel into the engine are determined, like in step 110 of FIG. 3, based on operating conditions of the engine.

The routine proceeds to step 320 wherein the charged voltage Vc of the capacitor C10 is determined. The ECU 100 is equipped with a voltage divider (not shown) which outputs a fraction of the charged voltage Vc to the microcomputer 130. The microcomputer 130 converts the input into a digital form indicating the charged voltage Vc.

The routine proceeds to step 330 wherein the value of the delay time of the valve-opening point is selected from the data map of FIG. 7 which corresponds to the charged voltage Vc, as derived in step 320.

The routine proceeds to step 340 wherein the time T that is the sum of the injection duration Tinj, as derived in step 310, and the correction time Td, as derived in step 330, is determined.

The routine proceeds to step 350 wherein the time T (=Tinj+Td), as derived in step 340, is determined as a target injection duration and stored in one of the signal outputting timer which corresponds to one of the cylinders #1 to #4 of the engine into which the fuel is to be injected subsequently. Additionally, the injection termination time, as determined in step 310, is also stored in the one of the signal outputting timers.

The ECU 100 of this embodiment, like the one in the first embodiment, works to advance the discharge start time when the capacitor C10 is to be discharged to energize the injector coil through steps 320 to 350 when the charged voltage Vc of the capacitor C10 is lower than the target voltage level to bring the valve-opening point in the capacitor-uncharged fuel injection mode into coincidence with that in the capacitor-charged fuel injection mode wherein the fuel is injected into the engine when the charged voltage Vc of the capacitor C10 is at the target voltage level.

When the charged voltage Vc of the capacitor C10 rises above the target voltage level due to a variation in characteristic of the charging circuit 50, the ECU 100 works to shorten the injection duration Tinj through steps 320 to 350 to retard the discharge start time when the capacitor C10 is to be discharged to bring the valve-opening point in the capacitor-uncharged fuel injection mode into coincidence with that in the capacitor-charged fuel injection mode.

Specifically, the ECU 100 of this embodiment is designed to control the valve-opening point of the injectors 101 to 104 accurately when the charged voltage Vc of the capacitor C10 is either decreased below or increased above the target voltage level.

### MODIFICATIONS OF THE FIRST EMBODIMENT

### First Modification

The ECU 100 of the first embodiment may be modified as discussed below.

The correction time Td, as determined in step 140 of FIG. 3, is the value calculated on the assumption that the charged voltage Vc of the capacitor C10 when the fuel injection is required to be performed one time before the mode of the capacitor-uncharged fuel injection appears is at the target voltage level (=65V). If, however, an actual value of the charged voltage Vc is different from the target voltage level, it will result in an error in determining the correction time Td. In order to alleviate this drawback, the ECU 100 may be designed to monitor the charged voltage Vc immediately before execution of the injection of fuel into the engine (e.g., the first of a sequence of injections of fuel in the multiple injection mode) preceding the capacitor-uncharged fuel injection, correct the correction time Td, as determined in step 140, based on a difference between the monitored value of the charged voltage Vc and the target voltage level, and use the corrected value of the correction time Td in step 160.

### Second Modification

If the value of the charged voltage Vc of the capacitor C10 is found, the delay time of the valve-opening point behind that in the mode of the capacitor-charged fuel injection (i.e., Vc=target voltage level), as already described, may be determined.

Therefore, if the injection of fuel to be executed next is determined to be the capacitor-uncharged fuel injection in step 120 of FIG. 3, the microcomputer 130 may be designed to measure the charged voltage Vc, calculate the delay time of the valve-opening point behind that in mode of the capacitor-charged fuel injection (i.e., Vc=target voltage level) using the measured value of the charged voltage Vc instead of execution of steps 130 and 140, and determine the calculated value of the delay time as the correction time Td to be used in step 160 without storing the values of the correction time Td in the nonvolatile memory in advance.

### MODIFICATIONS OF THE SECOND EMBODIMENT

The microcomputer 130 may be designed not to have the data map illustrated in FIG. 7. Specifically, the microcomputer 130 may use a measured value of the charged voltage Vc to calculate the delay time of the valve-opening point behind that in mode of the capacitor-charged fuel injection (i.e., Vc=target voltage level) in step 330 of FIG. 3.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

In the first embodiment, when the injection-to-injection interval (i.e., a time interval between two consecutive injection timings) is shorter than the stated period of time, the ECU 100 commences the later of the injections without charging the capacitor C10 (i.e., the capacitor-uncharged fuel injection) and corrects the discharge start time when the capacitor C10 starts to be discharged. The ECU 100 may alternatively be designed to change the charge permission signal, as outputted from the drive control circuit 120 to the charge control circuit 110, to the inactive level only during discharging of the capacitor C10 without inhibiting the capacitor C10 from being charged when the injection-to-injection interval is shorted than the stated period of time.

Specifically, when the charged voltage Vc of the capacitor C10 is at the target voltage level (=65V), and the injection of fuel is made one time, it will cause the charged voltage Vc to drop by 5.2V to 59.8V. If the equation (7), as shown below, is met where Tchg is the time required to charge the capacitor C10 from 59.8V to 65V, and Tint is the time interval between two consecutive starts of injection of fuel (i.e., injection timings), it will result in a difficulty in charging the capacitor C10 to bring the charged voltage Vc upto the target voltage level until the later of the starts of injection. “tp” in Eq. (7), as can be seen from FIG. 4(a), represents the discharge time required for discharging the capacitor C10 in which the charged voltage Vc is at the target voltage level to energize the injector coil until the target peak value ip is reached.

Tint<(tp+Tchg) (7)

The above described second modification of the first embodiment may further be modified as discussed below.

In step 120 of FIG. 3, it is determined whether Eq. (7) on two consecutive injections of fuel into the engine is met or not. If Eq. (7) is met, the microcomputer 130 measures the charged voltage Vc, calculate the delay time of the valve-opening point behind that in mode of the capacitor-charged fuel injection (i.e., Vc=target voltage level) using the measured value of the charged voltage Vc instead of execution of steps 130 and 140, and determine the calculated value of the delay time as the correction time Td to be used in step 160.

The ECU 100 may be used in the case where events of injection of fuel into two of the cylinders #1 to #4 belonging to either one of the first and second injector groups overlap each other. For instance, when events of injection of fuel into the first cylinder #1 and the fourth cylinder #4 belonging to the first injector group overlap each other, it will cause the later of the events of injection to be achieved at least partially while the capacitor C10 is being discharged to energize the coils 101a and 104a simultaneously. In such case, it is difficult to the equations, as described in the first embodiment. However, the correction time Td (i.e., the delay time of the valve-opening point) may be determined using values of resistance and inductance of the coils 101a and 104a connected in parallel in the equations.

In the case where fuel is injected in series several times in the multiple injection mode or overlapping injection mode, the ECU 100 may work to advance the discharge start time when the capacitor C10 is to be discharged for the second or subsequent one of the injections by the value of the correction time Td which is predetermined as a function of the pattern of the series of injection.

The ECU 100 may alternatively be equipped with a single injector.

What is claimed is:

1. A solenoid valve driver comprising:
a capacitor in which electric energy is stored which is to be discharged to energize a coil of at least one solenoid valve;
a charging circuit that charges said capacitor to bring a charged voltage of said capacitor to a target voltage level; and
a controller working to determine a discharge start time that is a time when said capacitor is to be started to be discharged to energize the coil of the solenoid valve and discharge said capacitor when the discharge start time is reached, when the discharge start time is reached in a condition that the charged voltage of said capacitor is out of the target voltage level, said controller advancing the discharge start time.

2. A solenoid valve driver as set forth in claim 1, wherein said controller stores a correction time for the discharge start time therein and corrects the discharge start time by the correction time.

3. A solenoid valve driver as set forth in claim 1, wherein said controller measures a value of the charged voltage of said capacitor before being discharged, said controller calculating a correction time based on the measured value of the charged voltage and correcting the discharge start time by the correction time.

4. A solenoid valve driver as set forth in claim 1, wherein the solenoid valve is an injector which is to be opened upon energization of the coil to inject fuel into an internal combustion engine.

5. A solenoid valve driver comprising:
a capacitor in which electric energy is stored which is to be discharged to energize a coil of at least one solenoid valve;
a charging circuit that charges said capacitor to bring a charged voltage of said capacitor to a target voltage level; and
a controller working to determine a discharge start time that is a time when said capacitor is to be started to be discharged to energize the coil of the solenoid valve and discharge said capacitor when the discharge start time is reached, said controller determining whether said capacitor is in a lack-of-charge state where the charged voltage is lower than the target voltage level or not, when it is determined that said capacitor is in the lack-of-charge state, said controller correcting the discharge start time to advance the discharge start time.

6. A solenoid valve driver as set forth in claim 5, wherein when it is determined that said capacitor will be in the lack-of-charge state at the discharge start time, said controller brings the discharge start time into coincidence with a time when said capacitor is to be discharged in a condition where the charged voltage is at the target voltage level.

7. A solenoid valve driver as set forth in claim 5, wherein said controller stores a correction time for the discharge start time therein and corrects the discharge start time by the correction time.

8. A solenoid valve driver as set forth in claim 5, wherein said controller measures a value of the charged voltage of said capacitor before being discharged, said controller calculating a correction time based on the measured value of the charged voltage and correcting the discharge start time by the correction time.

9. A solenoid valve driver as set forth in claim 5, wherein the solenoid valve is an injector which is to be opened upon energization of the coil to inject fuel into an internal combustion engine.

10. A solenoid valve driver comprising:
a capacitor in which electric energy is stored which is to be discharged to energize a coil of at least one solenoid valve;
a charging circuit that charges said capacitor to bring a charged voltage of said capacitor to a target voltage level; and
a controller working to determine a discharge start time that is a time when said capacitor is to be started to be discharged to energize the coil of the solenoid valve and discharge said capacitor when the discharge start time is reached, said controller measuring a value of the charged voltage of said capacitor before being discharged and correcting the discharge start time based on the measured value of the charged voltage.

11. A solenoid valve driver as set forth in claim 10, wherein the solenoid valve is an injector which is to be opened upon energization of the coil to inject fuel into an internal combustion engine.

12. A fuel injection apparatus comprising:
an injector equipped with a coil, said injector being opened to spray fuel upon energization of the coil;
a capacitor in which electric energy is stored which is to be discharged to energize the coil of said injector;
a charging circuit that charges said capacitor to bring a charged voltage of said capacitor to a target voltage level; and
a controller working to determine a discharge start time that is a time when said capacitor is to be started to be discharged to energize the coil of said injector and discharge said capacitor when the discharge start time is reached, said controller working to perform a sequence of spray operations to spray the fuel from said injector and advance the discharge start time for second or subsequent one of the sequence of spray operations.
